(19) United States
(12) Patent Application Publication
(10) Pub. No.: US 2021/0101038 A1
(43) Pub. Date: Apr. 8, 2021

(54) Fire Protection Sprinkler Frames and Assemblies

(71) Applicant: Minimax Viking Research & Development GmbH, Bad Oldesloe (DE)

(72) Inventors: Michael James OLDHAM, Kalamazoo, MI (US); Jed Edmond PIPE, Byron Center, MI (US); Shawn Gregory ORR, Grand Rapids, MI (US); Jonathan David DRAKE, Caledonia, MI (US); Lindsay Marie BARKER, Delton, MI (US)

(21) Appl. No.: 16/636,812

(22) PCT Filed: Jun. 7, 2019
(86) PCT No.: PCT/US2019/036005

§ 371 Date: Feb. 5, 2020

Related U.S. Application Data
(60) Provisional application No. 62/682,605, filed on Jun. 8, 2018.
(60) Provisional application No. 62/735,645, filed on Sep. 24, 2018.

(51) Int. Cl. A62C 35/68; A62C 37/11

(52) U.S. Cl. CPC A62C 35/68; A62C 37/11

(57) ABSTRACT

A fire protection sprinkler assembly having a frame that includes a pair of frame arms configured with a geometry that strengthens the frame arms to resist impact, shear and/or torsional loads. The sprinkler assembly can be configured for installation in any one of an upright sprinkler, a pendent sprinkler, horizontal sidewall sprinkler or a recessed sprinkler.

### PRIORITY DATA & INCORPORATION BY REFERENCE

This application claims the benefit of U.S. Provisional Application No. 62/682,605 filed Jun. 8, 2018 and U.S. Provisional Application No. 62/735,645 filed Sep. 24, 2018, each of which is incorporated by reference in its entirety.

### TECHNICAL FIELD

The present invention relates generally to fire protection sprinklers and more particularly is directed to preferred sprinkler frame and assembly configurations.

### BACKGROUND ART

Generally, automatic fire protection sprinklers include a frame for connection to a supply pipe of firefighting fluid and a deflection member coupled to the frame for distribution of the fluid to address a fire. The frame includes a formed body having an internal passageway with a fluid inlet for receipt of the fluid and a fluid outlet defining a discharge orifice from which the fluid is discharged. In an automatic sprinkler, the fluid discharge is automatically controlled by operation of a thermally responsive trigger or actuator that maintains a fluid tight seal at the discharge orifice by, for example, exertion of pressure on a cap (button or disc) or other sealing assembly disposed within the outlet. When the temperature surrounding the sprinkler is elevated within a range of the nominal temperature rating of the trigger, the trigger operates thereby permitting ejection and release of the sealing assembly and the discharge of fluid through the discharge orifice. The discharged fluid impacts the fluid deflection member and is distributed in a designed spray pattern and density in order to effectively address a fire and wet the surrounding area. Several factors can influence the water distribution patterns of a sprinkler including, for example, the installation orientation and the geometry of the fluid deflection member, the distance between the deflection member and the discharge orifice, and/or the shape of the sprinkler frame to which the deflection member is coupled.

In some automatic sprinklers, the fluid deflection member is coupled to the sprinkler frame at a fixed distance from the outlet. In many of these type of sprinkler assemblies, two frame structures or arms diametrically opposed about the outlet extend axially away from the frame body and converge toward one another to form a frame boss to which the fluid deflection member is affixed. The frame arms are shaped and dimensioned to coaxially align and space the frame boss and outlet from one another along a longitudinal axis of the sprinkler so as to support and centrally locate the fluid deflection member at the desired axial distance from the sprinkler outlet. This type of sprinkler frame and deflection member arrangement is well known in the art. Examples of such a sprinkler arrangement are shown and described in U.S. Pat. Nos. 1,945,450; 3,561,537; 4,136,740; 4,440,234; 4,623,023; 5,020,601; 5,097,906; 5,862,994; 5,865,256 7,137,455; and 9,265,981.

These patent documents illustrate the variety in the shape and size of the frame arms. For example, in U.S. Pat. No. 3,561,537, when viewing the sprinkler in elevation, each frame arm is shown extending from the body to the frame boss in a continuous arch. In contrast, U.S. Pat. No. 4,623,023 the sprinkler frame arms include linear sections that are angled with respect to one another as the arm extends from the frame body to the frame boss. In one type of frame arm geometry that is shown in U.S. Pat. Nos. 5,862,994 and 5,865,256, each frame arm includes a first substantially linear section that extends from the sprinkler body, parallel to the sprinkler axis, to form a pedestal portion of the frame arm. A second section of the frame arm that is contiguous with the pedestal portion, is substantially arcuate in its convergence toward the centrally located frame boss to define a swept arch portion of the frame arm.

When viewing the two frame arms and their convergence toward the frame boss, the sprinkler axis is centered between the frame arms. Accordingly, each of the frame arms define an arm profile when viewed from the perspective of the central sprinkler axis. These arm profiles can also vary between sprinklers. For example, in U.S. Pat. No. 5,862,994, the frame arm profile, when viewed from the sprinkler axis, tapers narrowly in width in a direction from the frame body to the frame boss with the outer edges of the profile curving toward one another symmetrically. In contrast, in U.S. Pat. No. 9,265,981, the frame arm profile viewed from the sprinkler axis remains substantially constant over the length of the arm from body to frame boss.

In addition to locating the fluid deflection member at a desired axial distance from the discharge orifice, the frame arms are configured to withstand and/or resist various forces and loads acting on the sprinkler. For example, the frame arms and frame boss are used for leverage in applying a compressive force against the thermally responsive trigger and seal assembly that is generated by a threaded screw member engaged in the frame boss. Moreover, the frame arms may be subject to intentional and unintentional impact, shear and/or torsional loads in the course of storage, transport, and installation of the sprinkler. Despite the variety in frame geometries, it is believed that there remains a need for a frame arm geometry to effectively resist and withstand such loading in to order to effectively maintain a sprinkler frame and fluid deflection member in its fixed operable arrangement.

This fixed deflection member and frame arrangement is used in all types of installation orientations and arrangements, e.g., upright, pendent, horizontal sidewall, and recessed or concealed. In a concealed type installation, the sprinkler extends through a through hole opening formed in a barrier such as, for example, a wall or ceiling. Generally, in such an installation, the sprinkler body is coupled to a supply pipe located behind the barrier and the fluid deflection member is located at a prescribed distance from the face of the barrier. In order to properly locate the deflection member relative to the barrier, it is well known to use a gauge plate or bracket that is coupled to the sprinkler frame. The gauge cooperates with the barrier or another structure to adjustably locate the sprinkler and its deflection member relative to the face of the barrier. U.S. Pat. Nos. 5,020,601 and 5,097,906 are two illustrative examples showing a fixed sprinkler and frame arrangement in which the sprinkler body is threaded or received into a central opening formed in a gauge plate. In each of U.S. Pat. Nos. 5,020,601 and 5,097,906, the gauge plate is limited to its location about the body of the sprinkler frame due to the external structure of the frame downstream of the body being greater than the central opening in the gauge plate. For example, the sprinkler frame in U.S. Pat. No. 5,097,906 includes an enlarged formation downstream of the external threads of the body that is shaped for engagement by an installation wrench or tool. The formation is larger in width than the sprinkler body and the central opening of the gauge bracket; and thus, the bracket is limited to a location about the body, upstream of the enlarged formation. Accordingly, there remains a need for sprinkler frames that can be used with components for recessed or concealed installations without requiring an enlarged external frame structure or formation to properly locate the installation components about the sprinkler.

U.S. Pat. No. 5,862,994 shows and describes an upright type of fire protection sprinkler. The fluid deflection member of the sprinkler includes a recessed central area and a group of spaced apart tines angled with respect to the recessed central area. According to the patent document, the recessed central area increased the fluid distribution density in an area located forty-five degrees (45°) with respect to the frame arms. U.S. Pat. No. 5,862,994 describes comparison fluid distribution testing in which the deflection member with the recessed central area provided a sufficient fluid density as compared to an otherwise similarly configured deflection member without a recessed central area, i.e., a “flat deflector,” which provided an insufficient fluid density. Accordingly, there remains a need for alternative upright type sprinkler and fluid deflection configurations capable of providing a desired fluid density distribution in particular areas below and about the sprinkler.

### DISCLOSURE OF INVENTION

Preferred embodiments of a fire protection sprinkler assembly are provided. The preferred sprinkler assembly includes a sprinkler frame having a pair of frame arms preferably configured to resist various loads on the sprinkler frame that may be experienced during handling, shipping, or installation or that are due to the external operating environment or personnel surrounding the installed sprinkler. In preferred embodiments, the frame arms define a preferred geometry that preferably strengthens the frame arms to resist impact, shear and/or torsional loads. In one preferred embodiment of a fire protection sprinkler, the sprinkler includes a body having an inlet, an outlet and an internal passageway extending between the inlet and the outlet along a longitudinal sprinkler axis. A sealing assembly is disposed in the outlet to occlude the outlet of the body. The preferred sprinkler further includes two frame arms with each of the frame arms preferably having a pedestal portion extending from the body generally parallel to the longitudinal sprinkler axis and a swept arch extending from the pedestal portion. The pedestal portion preferably has a linear surface profile and the swept arch preferably has a curvilinear surface profile. The linear surface profile and the curvilinear surface profile preferably define a peripheral surface of the frame arm and an interior surface of the frame arm that confronts the longitudinal sprinkler axis and a transition surface that extends between the peripheral and interior surfaces. A boss is preferably supported via the two frame arms at a fixed location along the longitudinal sprinkler axis. A fluid deflecting member is secured to the boss and spaced from the outlet at a fixed axial distance from the outlet; and a thermally responsive trigger disposed axially aligned along the longitudinal sprinkler axis between the sealing assembly and the fluid deflecting member. The transition surface of the frame arm preferably includes a first lateral edge and a second lateral edge that form a trapezoidal projection with the body and the boss. The trapezoidal projection is preferably centered along and symmetric about the longitudinal sprinkler axis.

Various sprinkler assemblies including the preferred sprinkler frame can be configured for installation as an upright sprinkler, pendent sprinkler, horizontal sidewall or a recessed or concealed sprinkler. One preferred embodiment provides for a recessed pendent sprinkler assembly in which the sprinkler frame includes an external thread with a thread stop to limit the threaded advancement of the sprinkler into an escutcheon assembly. A preferred recessed fire protection sprinkler assembly includes a sprinkler frame having a body having an inlet, an outlet and an internal passageway extending between the inlet and the outlet along a longitudinal sprinkler axis. The body includes a wrench boss for securing the body to a fluid supply pipe. The wrench boss defines a maximum width about the outlet. Two frame arms and a deflector boss are supported via the two frame arms at a fixed location along the longitudinal sprinkler axis, each of the frame arms has a pedestal portion extending from the body generally parallel to the longitudinal sprinkler axis and a swept arch between the pedestal portion and the deflector boss. The pedestal portion and the swept arch define a peripheral surface of the frame arm. The peripheral surfaces of the frame arms define a width about the outlet that is equal to or less than the maximum width of the wrench boss. The preferred recessed sprinkler assembly includes an escutcheon assembly having an outer cup and an adapter ring for adjustable surface contact within the outer cup. The adapter ring including a central opening defined by a female thread for receipt of the sprinkler frame. The sprinkler body includes an external male thread for engaging the female thread of the adapter ring and defines a diameter greater than the maximum diameter of the wrench boss. The external male thread preferably includes a defined thread stop to limit the threaded advancement of the frame into the adapter ring.

Another preferred embodiment of sprinkler assembly provides for an upright sprinkler assembly having an upright deflector with tine and slot formations at its periphery to distribute fluid discharged from the sprinkler frame in a preferred manner. A preferred upright fire protection sprinkler includes a body having an inlet, an outlet and an internal passageway extending between the inlet and the outlet along a longitudinal sprinkler axis. The body including a wrench boss for securing the body to a fluid supply pipe. Two frame arms extend from the body with each frame arm having a pedestal portion and a swept arch portion. A preferred upright fluid deflecting member is spaced from the outlet at a fixed axial distance. The upright fluid deflecting member preferably includes a circular member having an upper surface, a lower surface and a periphery including a plurality of spaced apart tines formed about a central deflector axis with a plurality of slots formed between each tine. The deflecting member preferably includes a radius formed at the periphery about the deflector axis between the lower surface and a terminal portion of the slot formation to direct fluid downward about the sprinkler.

### BRIEF DESCRIPTION OF DRAWINGS

The accompanying drawings, which are incorporated herein and constitute part of this specification, illustrate exemplary embodiments of the invention, and together, with the general description given above and the detailed description given below, serve to explain the features of the invention. It should be understood that the preferred embodiments are some examples of the invention as provided by the appended claims.

FIG. 1 is an elevation view of a preferred embodiment of a fire protection sprinkler.

FIG. 2 is a cross-sectional view of the sprinkler of FIG. 1.

FIG. 3 is another cross-sectional view of the sprinkler of FIG. 1 taken along line III-III.

FIG. 4 is a partial cross-sectional perspective view of a preferred sprinkler frame for use in the sprinkler of FIG. 1.

FIG. 5 is a plan view of the preferred sprinkler frame for use in the fire protection sprinkler of FIG. 1.

FIGS. 5A-5F are partial cross-sectional views of a frame arm for use in the preferred sprinkler frame of FIG. 5.

FIG. 6 is an exploded partial cross-sectional view of a preferred embodiment of a recessed sprinkler assembly.

FIGS. 7 & 7A-7B are various views of a preferred upright fluid deflector.

FIGS. 8-8A are plan and side schematic views of a preferred fluid distribution arrangement for testing preferred embodiments of the sprinkler with the upright fluid deflector of FIG. 7.

### MODE(S) FOR CARRYING OUT THE INVENTION

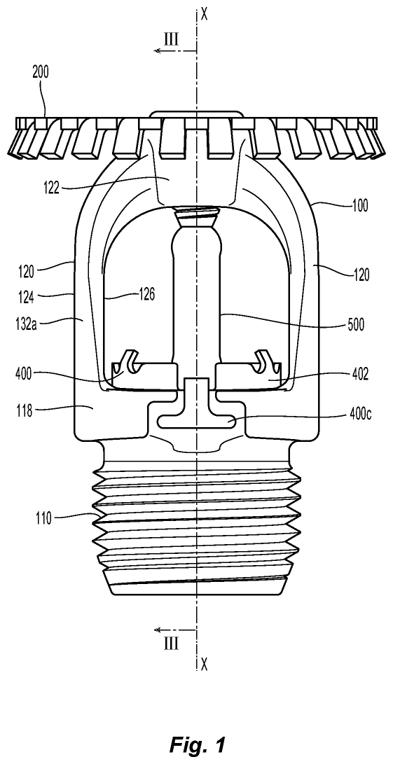

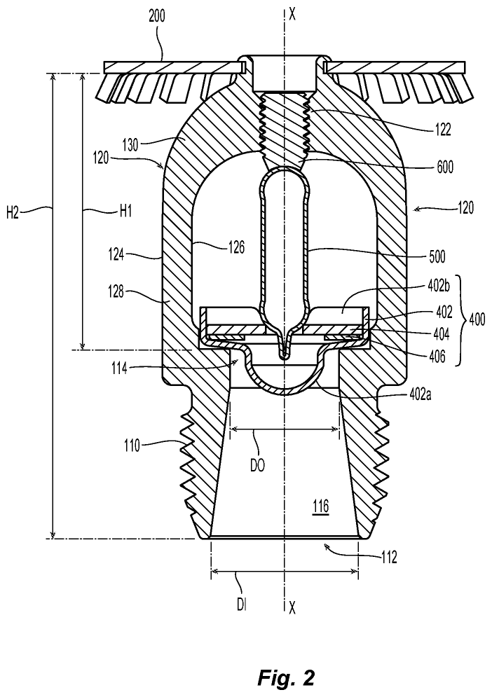

Shown in FIGS. 1 and 2 is a preferred embodiment of a fire protection sprinkler 10 having a preferred sprinkler frame 100 for securing to a supply pipe of firefighting fluid. A fluid deflecting member or deflector 200 is coupled to the frame 100 for distributing the firefighting fluid to address a fire. The frame 100 includes a body 110 having an inlet 112, an outlet 114 and an internal passageway 116 axially aligned with one another along a longitudinal sprinkler axis X-X. The preferred frame includes a pair of frame arms 120 to support and locate the deflector 200 at a fixed distance along the longitudinal sprinkler axis from the outlet 114. The pair of frame arms 120 extend from the body 110 at diametrically opposed sides of the outlet 114 and converge toward one another to form and/or support a deflector boss 122 that is centered along the sprinkler axis X-X at a fixed distance from the outlet 114. The deflector 200 is affixed to the boss 122 to locate the deflector 200 at a first fixed distance H1 from the outlet 114 and at a second fixed distance H2 from the inlet 112. The deflector is illustratively shown bent or formed for installation in an upright orientation in which supplied firefighting fluid is discharged from the outlet 114 to impact the deflector 200 in an upward direction. Alternatively, the affixed deflector can be formed or configured for a pendent orientation in which fluid is discharged in a downward direction or in a sidewall orientation in which water is discharged horizontally.

Firefighting fluid is delivered to the inlet of the sprinkler at a working pressure and discharged from the outlet to impact the deflector for distribution in an expected density and/or geometry about the sprinkler. Accordingly, it is desirable to maintain the proper position of the deflector 200 with respect to the outlet 114. The frame arms 120 are preferably configured to resist various loads on the sprinkler frame 100 that may be experienced by the sprinkler, in the course of handling, shipping, or installation or that are due to the external operating environment or personnel surrounding the installed sprinkler. In particular, the frame arms 120 define a preferred geometry that strengthens the frame 100 in a region between the deflector 200 and the frame body 110 to resist impact, shear and/or torsional loads on the frame 100.

As seen in FIGS. 1 and 2, each of the frame arms 120 has a peripheral surface 124 and an interior surface 126 with respect to the sprinkler axis X-X with the interior surface 126 being closest to or confronting the longitudinal axis X-X. The peripheral and interior surfaces 124, 126 extend from the body 110 to the boss 122 to define the frame arm profile. Each frame arm 120 preferably includes a pedestal portion 128 defined by a linear portion of the linear frame arm profile that extends from the body 110 generally parallel to the longitudinal sprinkler axis X-X. Preferably contiguous with the pedestal portion 128 is a swept arch portion 130 defined by a curvilinear profile portion of the frame arm that extends between the pedestal portion 128 and the boss 122.

With reference to FIG. 2, the profile of the peripheral and interior surfaces 124, 126 can vary over a portion of the frame arm 120 in the direction from the body 110 to the boss 122. Alternatively, or additionally, the profile of the peripheral and interior surfaces 124, 126 can remain constant over the same or different portion of the frame arm 120 in the direction from the body 110 to the boss 120. For the pedestal portion 128, preferred embodiments of the peripheral surface 124 and planar interior surface 126 described herein extend parallel to one another to define the preferred linear profile of the frame arm pedestal portion 128. For the preferred swept arch portion 130, the peripheral and interior surfaces 124, 126 curve about different centers of curvatures.

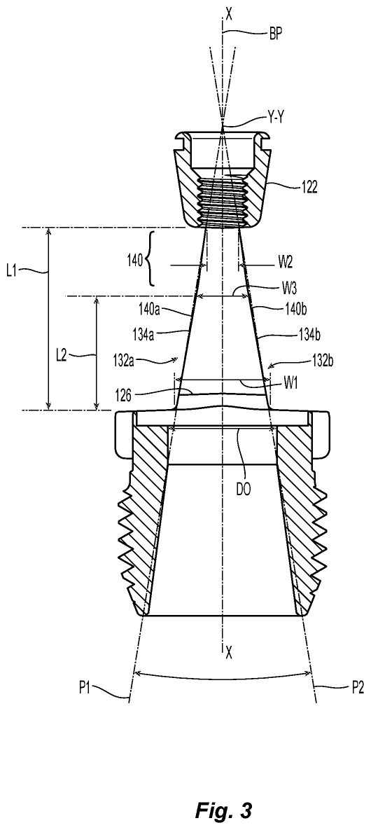

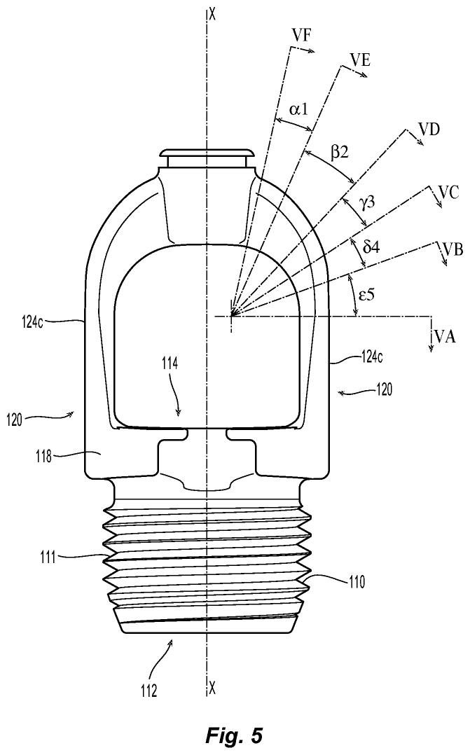

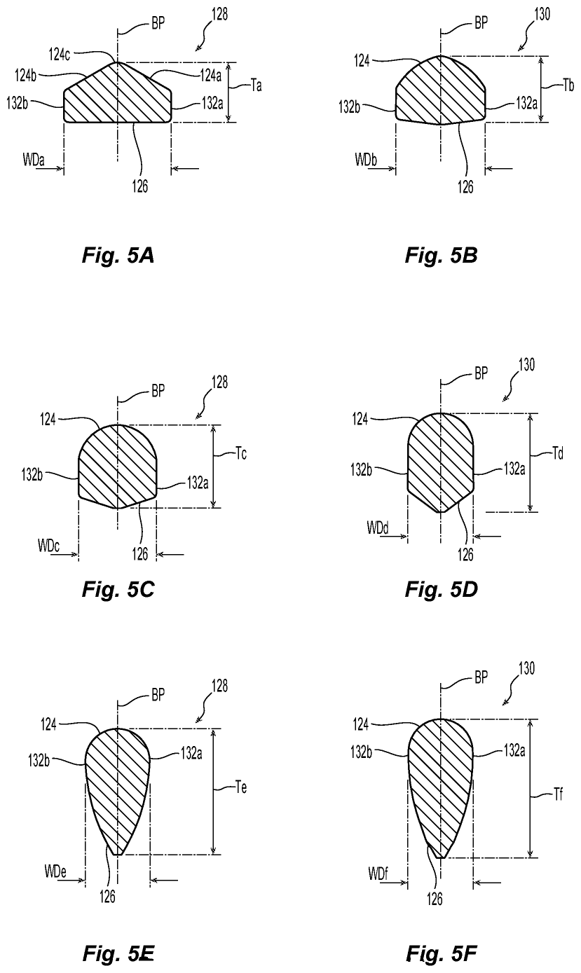

Each of the frame arms 120 includes a transition surface 132 that extends between the peripheral surface 124 and the interior surface 126. Referring to FIG. 1 and the cross-sectional view of a frame arm in FIGS. 5A-5F, the peripheral, interior and transition surface 124, 126, 132 are contiguous with one another to define the various cross-sectional views of the preferred pedestal and swept arch portions 128, 130. As shown in FIG. 3 and FIGS. 5A-5F, each of the frame arms 120 is preferably symmetrical about a sprinkler bisecting plane BP in which lies or includes the sprinkler axis X-X. The transition surface 132 preferably includes a first side or flank 132a and a second side or flank 132b, which are preferably disposed in respective first plane P1 and second planes P2 spaced apart about the bisecting plane BP to define the maximum width of any given cross-section of the frame arm 120.

Referring specifically to FIG. 3 and the elevation view of the interior surface 126 of the frame arm 120 confronting the sprinkler axis X-X, the first and second flanks 132a, 132b preferably converge toward one another over each of the pedestal portion 128 and swept arch portion 130 of the frame arm so that their respective first and second planes P1 and P2 converge to define a line of intersection Y-Y in the bisecting plane BP that preferably extends perpendicular to and intersects the sprinkler axis X-X. The first and second planes P1, P2 are each obliquely angled with respect to the bisecting plane BP to define an included angle therebetween that preferably ranges between 15°-25° degrees and is preferably twenty degrees) (20°. The first and second flanks 132a, 132b respectively define a first lateral edge or surface 134a and a second lateral edge or surface 134b. The edges 134a, 134b preferably taper or angle toward one another and the bisecting plane BP at a constant rate from the body 110 to the boss 122. The edges 134a, 134b collectively and in combination with the boss 122 and body 110 define a preferably trapezoidal perimeter 140 of a trapezoidal projection as described herein.

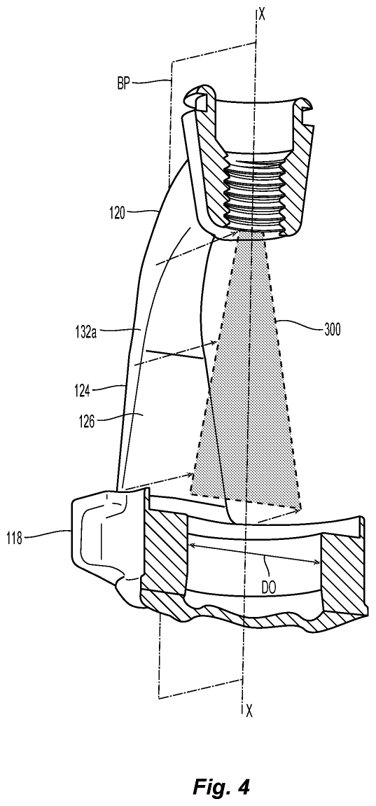

As shown in FIG. 4, the preferred perimeter geometry 140 defines a trapezoidal planar projection 300 that is perpendicularly oriented to the bisecting plane BP and centered along the sprinkler axis X-X. Accordingly, the interior surfaces 126 of each of the pedestal portion 128 and the swept arch portion 130 preferably respectively define a trapezoidal portion of the projected trapezoidal perimeter 140a, 140b as seen in FIG. 3. For preferred embodiments of the frame 100, the trapezoid perimeter 140 is preferably defined by an overall trapezoid length L1 of about 0.75 inch (19.05 mm) and is more preferably about 0.728 inch (18.49 mm). The portion of the trapezoid length extending over the pedestal portion 128 is defined by a trapezoid secondary length L2 of about ½ inch (12.7 mm) and is more preferably 0.45 inch (11.43 mm). The secondary length L2 preferably extends over the entire pedestal portion 128 to define its vertical length. The width of the trapezoid perimeter varies preferably at a constant rate over its length L1. At the base of the trapezoid proximate the body 110, the trapezoid defines a first width W1 that is preferably about ½ inch (12.7 mm) and is more preferably about 0.4 inch (10.16 mm). The top of the trapezoid 140 defines a second width W2 proximate the boss 122 that preferably ranges from 1/16 inch to ⅛ inch (1.6-3.2 mm) and is more preferably 0.09 inch to 0.095 inch (2.2-2.4 mm). At or proximate the projection of the junction between the pedestal portion 128 and the swept arch portion 130, the trapezoid defines a preferred third width W3 that ranges from ⅛ inch to ¼ inch (3.2-6.4 mm) and is more preferably 0.213 inch (5.4 mm). In defining the preferred trapezoidal projection geometry, the frame arm from the body 110 to the boss 122 can provide a resistance to various impact, shear or torsional loads. In particular, the preferred frame arm geometry can resist such variable loads applied to the deflector 200 or the swept arch portion 130 of the frame arm 120 when the sprinkler is being handled or installed.

The interior surface 126 within the trapezoidal perimeter can be planar or non-planar. Referring to FIGS. 5A-5F, are various cross-sectional views of a preferred frame arm 128 with FIG. 5A showing a cut through the preferred pedestal portion 128 and FIGS. 5B-5F showing different cuts through the swept arch portion 130. The one or more surfaces of the peripheral and interior surfaces 124, 126 each cross or intersect the bisecting plane BP in extending from the first flank 128a to the second flank 128b. For example, as seen in FIG. 5A, the interior surface 126 of the pedestal portion 128 is preferably a planar surface disposed perpendicular to the bisecting plane BP. Alternatively, the interior surface 126 of the pedestal portion 128 in the swept arch portion 130 can include two or more non-planar surfaces disposed at a generally skewed angle with respect to the bisecting plane BP as seen for example in FIGS. 5B-5F. The peripheral surface 124 of the pedestal portion 128 can include two or more non-planar surfaces disposed at a generally skewed angle with respect to the bisecting plane BP. In a preferred aspect of the peripheral surface 124, two planar surfaces 124a, 124b are symmetrically disposed about the bisecting plane BP to define a ridge 124c extending along the pedestal portion 128, as seen in FIG. 5A. FIGS. 5B-5F show the peripheral surface formed as a radiused or curved surface centered about the bisecting plane BP.

FIG. 2 shows the cross-sectional view of the body 110 and its internal passageway. Fluid supplied to the sprinkler inlet 112 flows through the internal passageway 116 and is discharged from the outlet 114 to impact the deflector 200 to address a fire. In a preferred embodiment, the deflector 200 is located at a preferred first fixed distance H1 from the outlet 114 that ranges from 1 inch to 1.25 inches (25.4-31.8 mm) and is more preferably about 1.125 inches (28.6 mm). In the preferred embodiment, the deflector 200 is correspondingly located at a preferred second fixed distance H2 from the inlet 112 that ranges from 1.75 inches to 2 inches (44. 5-50.8 mm) and more preferably ranges from 1.85 inches to 1.95 inches (47-49.5 mm) and is even more preferably about 1.9 inches (48.3 mm). The inlet 112 defines a first internal diameter DI of the sprinkler body 110 and the outlet 114 defines a second internal diameter DO, which is smaller than the inlet diameter DI. The internal passageway 116 preferably tapers narrowly from the inlet 112 to the outlet 114. More preferably, diametrically opposed surfaces defining the internal passageway 116 define an included angle of about twenty degrees (20°) about the sprinkler axis X-X. The discharge characteristics from the sprinkler body 110 and its outlet 114 are preferably quantified by the industry accepted discharge coefficient or nominal K-factor defined from the formula: K-factor=Q÷√P where Q is fluid flow rate from the sprinkler for a given fluid starting pressure P, each of which is measured in appropriate metric or English units. Preferred embodiments of the sprinkler body 110 defines a nominal K-factor that is preferably less than K 11.2 GPM/(PSI)^{1/2} [160 LPM/(BAR)^{1/2}] (hereinafter K11) and is preferably one of K 8.0 GPM/(PSI)^{1/2} [115 LPM/(BAR)^{1/2}]) (hereinafter K8) or a K 5.6 GPM/(PSI)^{1/2} [80 LPM/(BAR)^{1/2} (hereinafter K5.6). Alternative preferred embodiments of the sprinkler body described herein can have a nominal K-factor greater than K11, for example, a nominal K-factor of K 28.0 GPM/(PSI)^{1/2} [400 LPM/(BAR)^{1/2}] (hereinafter K11).

The sprinkler body passageway and the frame arms 120 define one or more preferred dimensional relationships to provide a preferred sprinkler frame structure for load resistance. For example, the outlet diameter DO can define one or more preferred dimensional relationships with respect to the trapezoidal perimeter 140 of the frame arm trapezoidal projection 300. With reference to FIG. 3, the outlet diameter DO is preferably about 0.5 inch (12.7 mm) and for a K8 sprinkler, the diameter DO is 0.52 inch (13.2 mm) with the diameter for a K5.6 being preferably 0.44 inch (11.2 mm). Each of the preferred width dimensions W1, W2, W3 of the trapezoidal perimeter define a preferred ratio to the outlet diameter. For example, for the K8 sprinkler, the trapezoidal perimeter 140 defines the following preferred width-to-outlet diameter ratios: W1:DO being about 0.77:1; W2:DO being about 0.17:1; and W3:DO being about 0.4:1. For the preferred K5.6 sprinkler, the trapezoidal perimeter 140 defines the following preferred width-to-outlet diameter ratios: W1:DO being about 0.9:1; W2:DO being about 0.2:1; and W3:DO being about 0.5:1.

Alternatively, or additionally, the outlet diameter DO defines one or more preferred relationships with respect to the pedestal and swept arch portions 128, 130. As shown in the cross-sectional views of FIGS. 5A-5F, the first and second lateral flanks 132a, 132b, at their maximum spacing about the bisecting plane BP, define the width (WDa, WDb, WDc, WDd, WDe, WDf) of the given cross-section. With cross-section VA being taken in a plane perpendicular to the bisecting plane BP and axis X-X, the remaining cross-sections (VB, VC, VD, VE and VF) are taken at the following respective angles from the plane of VA: 19.8°; 33.3°; 46.9°; 66.3°; and 77.5°. For the preferred embodiments and six cross-sections shown, the junction between the pedestal and swept arch portions 128, 130 define a width WDa of 0.213 inch. Moving in a direction toward the boss 122 through the swept arch portion 130, the section width WDb is preferably 0.177 inch and the remaining widths WDc, WDd, WDe, WDf are preferably 0.130 inch. Accordingly, for each embodiment of a sprinkler and its swept arch portion 130 define at least three preferred width (WD)-to-outlet diameter (DO) ratios. For the K8 sprinkler the first ratio of WDa:DO is preferably 0.4:1; the second ratio WDb:DO is preferably 0.3:1: and the third ratio defined by, for example, WDf:DO is preferably 0.25:1. For the K5.6 sprinkler the first ratio of WDa:DO is preferably 0.5:1; the second ratio WDb:DO is preferably 0.4:1: and the third ratio defined by, for example, WDf:DO is preferably 0.3:1.

The peripheral and interior surfaces 124, 126 at their maximum spacing in the bisecting plane define the preferred thickness (Ta, Tb, Tc, Td, Te, TO in each of the frame arm sections shown. The junction between the pedestal and swept arch portions 128, 130 define a preferred frame arm thickness Ta of 0.126 inch (3.2 mm). Moving in a direction toward the boss 122 through the swept arch portion 130, the section thicknesses continue to increase. For example, the thicknesses preferably increase as follows: from a thickness Tb of 0.130 inch (3.3 mm) to subsequent thicknesses Tc of 0.171 inch (4.3 mm), to thicknesses Td of 0.202 inch (5.1 mm; to thickness Te of 0.256 inch (6.5 mm), and to thickness Tf of 0.281 inch (7.1 mm). In combination with the preferred trapezoid perimeter 140 described, each embodiment of a sprinkler and its swept arch portion 130 define preferred thickness (T)-to-outlet diameter (DO) ratios. For the K8 sprinkler the following ratios are preferably defined: first ratio of Ta:DO is preferably 0.24:1; the second ratio Tb:DO is preferably 0.25:1: and the third ratio Tc:DO is preferably 0.33:1; the fourth ratio Td:DO is preferably 0.38:1; the fifth ratio Te:DO is preferably 0.49:1 and the sixth ratio Tf:DO is preferably 0.54:1. For the K5.6 sprinkler the following ratios are preferably defined: first ratio of Ta:DO is preferably 0.29:1; the second ratio Tb:DO is preferably 0.3:1: and the third ratio Tc:DO is preferably 0.39:1; the fourth ratio Td:DO is preferably 0.46:1; the fifth ratio Te:DO is preferably 0.58 and the sixth ratio Tf:DO is preferably 0.64:1.

With reference to FIG. 5, the outer surface of the sprinkler body 110 is configured for connecting the sprinkler 10 to a fluid supply pipe. For example, a K5.6 sprinkler preferably includes an external male pipe thread 111 configured as ½ inch-14 NPT. For the larger K8 sprinkler the external pipe thread can be configured as ½ inch-14 NPT or alternatively as ¾ inch-14 NPT pipe. To facilitate securement of the sprinkler 110 to the fluid pipe, the sprinkler body 110 includes a wrench boss 118 with a hexagonal perimeter disposed about the outlet 114 and centered about the sprinkler axis X-X for engagement by an installation tool, such as for example, a sprinkler installation wrench. Two pairs of adjacent wrench flats of the hexagonal perimeter are preferably contiguous with the pedestal portion 128 and its peripheral surface 124 such that the vertex between the adjacent flats of the hexagonal perimeter is aligned with the preferred ridge 124c. The diametrically opposed vertices about the outlet 114 preferably define a maximum width of the wrench boss 118. Alternatively or additionally, opposed flats of the hexagonal flats can define a maximum width of the wrench boss 118.

Preferred embodiments of the sprinkler 10, are preferably configured as automatic sprinklers such that fluid discharge from the connected sprinkler 10 and its outlet 114 is controlled by a seal assembly 400 that is disposed within the passageway 116 proximate the outlet 114 as seen in FIGS. 1 and 2 to occlude the outlet 114. The seal assembly 400 preferably includes a shell cap 402 with a seating disc 404 to enclose an annular spring disc 406 within the shell cap 402. The shell cap 402 includes a preferably bulbous surface 402a exposed to the inlet 112 and an opposite surface 402b that forms a receptacle for housing each of the spring disc 406 and seating disc 404. The shell cap includes one or more legs 402c to fold over a preferably formed notch in the hexagonal perimeter of the wrench boss 118 preferably centered between the frame arms 120. The seal assembly 400 is supported within outlet 114 of the sprinkler body 110 by a thermally responsive element or trigger 500 seated within the central through hole of the seating disc 404 and preferably aligned along the sprinkler axis X-X between the sealing assembly 400 and the deflector 200. The thermally responsive element 500 is preferably embodied as a thermally responsive frangible glass bulb but can be alternatively embodied as a thermally responsive mechanical or electrically actuated assembly provided the assembly can seat and unseat the seal assembly 400 in respective unactuated and actuated states of the sprinkler. In the presence of a sufficient level of heat, the thermally responsive element 500 operates or triggers to release the sealing assembly 400 and permit the supplied fluid to discharge from the outlet 114 to impact the deflector 200 and address a fire.

A load screw 600 is threaded into the boss 122 to provide a loading force against the thermally responsive element 500 and the seating disc 404 to compress the spring disc 404 such that the assembly 400 seats within the outlet 114 of the sprinkler body 110 to form a fluid tight seal. To form a preferred fluid tight seal, the surface contact between the shell cap 402 and the surface defining the outlet 114 is preferably at a constant radius about the sprinkler axis X-X. Accordingly, the surface defining the outlet diameter DO at the outlet 114 is sufficiently circular to form the preferred circular fluid tight surface contact with the shell cap 402. In a preferred aspect, the diameter DO at the outlet 114 when measured at multiple points is preferably within an acceptable variance of one another to provide the preferred circularity at the outlet 114. More particularly, regardless of the number of multiple outlet diameter DO measurements taken at the outlet 114, no two diameter measurements vary by no more than 25% of a manufacturing tolerance variability for forming the outlet diameter DO at the outlet 114. In one preferred embodiment of a K5.6 in which the outlet diameter DO is 0.518 inch (13.157 mm) subject to a tolerance of ±0.002, any two measured diameters preferably do not vary by more than 0.001 inch.

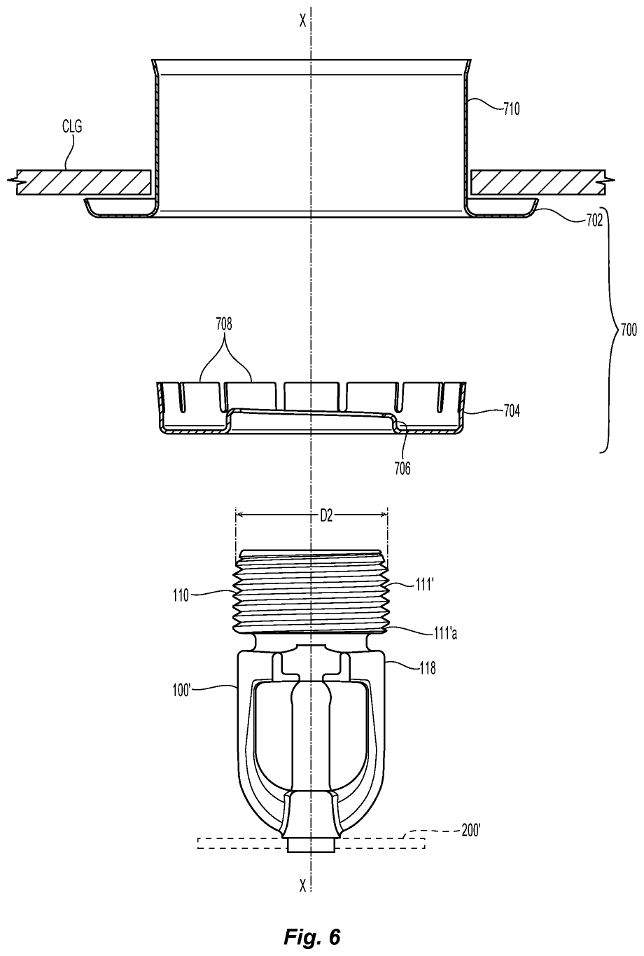

As previously noted, each of the sprinklers can be appropriately configured for any one of an upright, pendent or horizontal/sidewall installation. Moreover, for pendent and sidewall type installations, the sprinkler can be installed in a recessed configuration within an appropriately sized escutcheon. Show in FIG. 6 is an exploded view of preferred recessed sprinkler assembly with an adjustable escutcheon assembly 700. The escutcheon assembly 700 includes an outer cup 702 which houses an internal adapter ring 704 for securely centering a sprinkler 10 within the outer cup 702. The adapter ring 704 includes a central opening formed by a female thread 706 for threadedly engaging the external male thread 111′ of the sprinkler 10 to secure the sprinkler 10 within the adapter ring 704. The adapter ring includes two or more flexible tabs 708 formed at the periphery of the adapter ring 704. The flexible tabs 708 flex allow axial insertion of the adapter ring 704 into the outer cup 702. The tabs 708 of the ring 704 form a surface contact with the interior surface 710 of the outer cup 702 to allow for axial adjustment of the adapter ring 704 within the outer cup 702. The outer cup 702 includes a flanged portion for abutting a mounting surface such as, for example, a wall or ceiling CLG. The adapter ring slides within the outer cup to adjustably locate the sprinkler 10 and its deflector 200′ at an operational distance from the mounting surface. For a sprinkler frame 100 in which the wrench boss 118 defines a width or girth that is greater than the outer diameter of the body 110 and its external thread 111, as shown for example in FIG. 5, insertion and threaded advancement of the frame 100 into the central opening of the adapter ring 704 of the escutcheon assembly is limited by the interference between the wrench boss 118. Such a frame configuration can therefore prevent or eliminate over-threading the sprinkler frame into the adapter ring 704 and thus maintain secured engagement between adapter ring 704 and the sprinkler frame 100.

Shown in FIG. 6 is an alternate embodiment of a sprinkler frame 100′ in which the body 110 and its external thread 111′ define a diameter D2 (maximum diameter or pitch diameter) that is equal to or greater than the maximum width of the wrench boss 118 and/or the maximum width defined between the peripheral surfaces of the frame arms 120. Accordingly, the wrench boss 118 cannot limit the threaded advancement of the frame 110 into the adapter ring 704. Instead, the external thread 111′ includes an incomplete thread, thread break or thread stop 111′ a at the trailing end of the external thread. In a preferred embodiment of the external thread 111′, the external thread includes a first thread portion and a second thread portion different than the first portion with the difference or discontinuity between the first and second thread portions forming the preferred thread stop 111′ a. Any attempt to advance the adapter ring beyond the thread stop 111′ a will instead preferably result in the adapter ring 704 securely stopping on the sprinkler frame 110 and the thread 111′. Therefore, the thread break 111′ a limits the advancement of the frame 110 to secure the engagement between the sprinkler 10′ the adapter ring 704.

In one preferred embodiment of the recessed sprinkler assembly, the external thread 111′ is a tapered thread. For example, in one particular exemplary embodiment of a K8, the tapered thread is preferably a ¾ inch-14 NPT thread with a maximum diameter of 1.052 inches (26.7 mm) at its trailing end adjacent the wrench boss 118. Proximate the trailing end of the thread is the preferred thread break 111′ a. More preferably, the thread break 111′ a is located over 0.5 inch (12.7 mm) from the leading end of the thread 111′ proximate the inlet 116 of the sprinkler frame with a preferred pitch diameter of 1.0033 inch (25.4 mm) located axially at a minimum 0.5 inch (12.7 mm) from the leading end of the thread 111′a. The mating female thread 706 of the adapter 704 is preferably configured as a straight thread and more preferably configured as a national pipe straight thread with a nominal thread diameter that is preferably smaller than that of the external thread 111′ of the sprinkler. Accordingly, in a preferred embodiment of the assembly shown in FIG. 6, the female thread 706 of the adapter ring 704 is configured as ¾ inch-14 NPSC with a maximum pitch diameter of 1.016 inch (25.8 mm) and a minimum pitch diameter of 1.006 inch (25.6 mm). The helical female thread 706 preferably does not make a complete revolution about its central axis such that the start and the end of the female thread are separated by a gap in between of about 0.125 inch (3.2 mm) when viewed in plan. In another exemplary embodiment of a K5.6 sprinkler frame, the tapered external male thread is preferably a ½ inch-14 NPT thread with the thread break 111′ a at the trailing end adjacent the wrench boss 118. Correspondingly, the female thread 706 of the adapter ring 704 is configured as ½ inch-14 NPSC. Other aspects of the preferred recessed sprinkler assembly can be alternatively configured. For example, instead of providing flexible tabs in the adapter ring 704, the adapter can include a helical or corrugated surface for threaded engagement with a corresponding surface 710 formed within the outer cup 702.

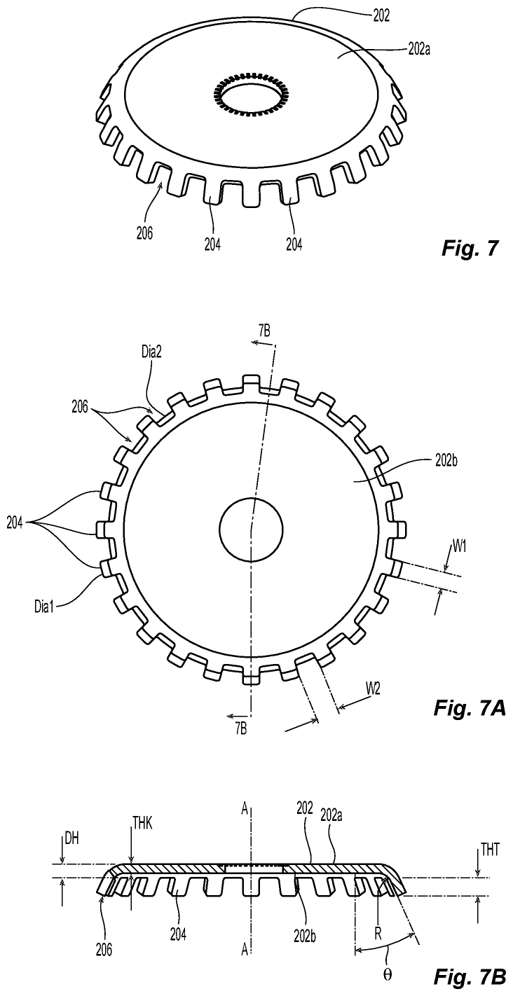

Preferred embodiments of the sprinkler have been tested to evaluate its effectiveness in addressing fires and distributing fluid in a preferred manner. An embodiment of an upright sprinkler 10, as seen in FIG. 1, was configured with the preferred upright fluid deflector 200′ as shown in FIGS. 7, 7A and 7B and subjected to fire and fluid distribution testing. The deflector 200′ is a preferably circular having a planar member 202 circumscribed about a central deflector axis A-A to define an upper surface 202a and a lower surface 202b that are preferably disposed parallel to one another to define a deflector thickness THK therebetween that ranges from 0.045-0.05 inch (1.1-1.3 mm) and is preferably 0.047 inch (1.2 mm). When mounted to the sprinkler frame 100, the deflector 200′ is supported by the sprinkler frame arms 120 and boss 122 with the deflector axis coaxially aligned with the sprinkler axis X-X in a manner as previously described such that the lower surface opposes the outlet 114 of the sprinkler frame 110. Accordingly, the deflector 200′ includes a central opening to receive the boss 122. Moreover, given the preferred configuration of the deflector 200′ shown, each of the upper surface 202a, and lower surface 202b are disposed perpendicular to the sprinkler axis X-X.

At the periphery of the deflector 200′ are a plurality of spaced apart tines 204 with slots formed in between. The tines 204 preferably extend and are angled downward from the planar member 202 to define an included angle θ with a line parallel to the central deflector axis A-A. In preferred embodiments, the included angle θ preferably ranges from 20°-30°, more preferably ranges from 22°-28°, yet is even more preferably 25°. The tines define a first deflector height THT from the lower surface 202b to the terminal end of the tine 204 that preferably ranges from 0.1-0.2 inch (2.5-5 mm) and more preferably ranges from 0.1-0.15 inch (2.5-3.8 mm) and is even more preferably 0.12 (3 mm). Moreover, the deflector 200's and the included tine angles θ are formed such that there is a radius R that is formed at the periphery that is constant about the central deflector axis A-A. Accordingly, even at the slot formations 206, the radius R extends a portion of the deflector downward with respect to the central portion 202 to define a second deflector height DH between the upper surface 202a and the terminal edge of periphery forming the slot 206 that preferably ranges from 0.05-0.1 inch (1.3-2.5 mm) and is more preferably 0.07 inch (1.8 mm). Fluid discharged from the outlet that impacts the deflector and the lower surface 202b flow radially toward the slots 206 and are directed radially and downward about the sprinkler. In preferred embodiments of the formed deflector 200′, the tines 204 define a maximum diameter Dial of the deflector, as shown in FIG. 7A, that preferably ranges from 1½ inch to 1¾ inch (38.1-44.5 mm) and is more preferably 1⅔ inch (1.667 in.) (42.4 mm) with the terminal ends of the slots 206 define a smaller second diameter Dia2 that ranges from 1.4-1.5 inch (35.6-38.1 mm) and is more preferably 1.45 inch (36.8 mm). A total of twenty-four (24) tines 204 each having a preferred width W1 ranging from 0.08-0.09 inch (2-2.3 mm) and preferably 0.085 inch (2.2 mm) are equally spaced about the deflector axis A-A at a preferred 15° tine-to-tine spacing. The slots 206 define a preferred slot width W2 of about 0.09-0.1 inch (2.3-2.5 mm) and more preferably 0.098 inch (2.48 mm).

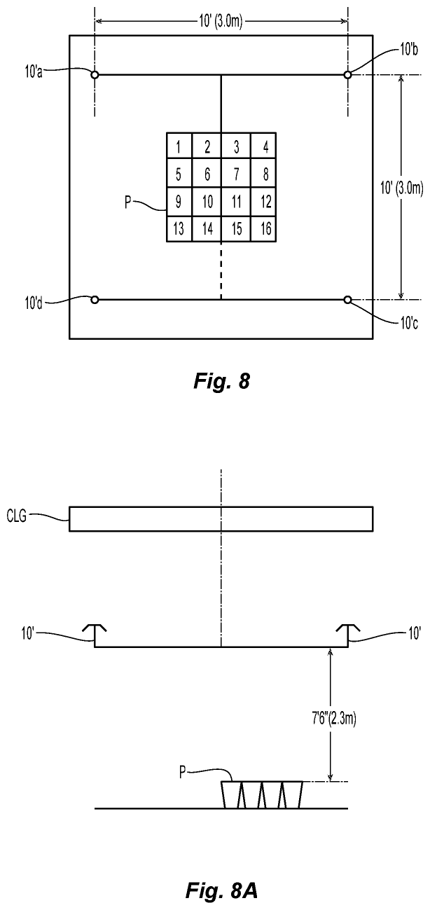

Preferred embodiments of the upright sprinkler 10 with the preferred deflector 200 were subjected to fire and fluid distribution testing. The sprinkler frames were configured with a ½ inch orifice diameter to define a nominal K-factor of a K5.6. In one preferred fluid distribution test, schematically shown in FIGS. 8 and 8A, four open (unsealed) test sprinklers 10′a, 10′b, 10′c, 10′d are spaced apart on a 10 ft.×10 ft. sprinkler-to-sprinkler spacing be with an array of sixteen collection pans P (1-16) centered below the four test sprinklers. The four sprinklers were installed with their deflectors 200′ located seven inches (17.8 cm.) below the test ceiling CLG and 7½ feet (2.3 m.) above the top of the collection pans P. Each of the test sprinklers was coupled to water supply piping that is sized to provide a flow of 15 GPM (56.8 LPM) per each test sprinkler. The test piping is preferably nominal 1½ piping. The frame arms were preferably oriented parallel to the test piping. Water was supplied to the four open sprinklers 10′a, 10′b, 10′c, 10′d and discharged for 10 minutes and collected in the collection array P. Each collection pan is 12 in.×12 in.×12 in. (30.5 cm.×30.5 cm.×30.5 cm) in volume. The fluid density in each pan was determined and the total averaged. The test is conducted generally in conformance with the “16 Pan Distribution Test” in Section 51 of the industry accepted standard, “UL 199: Automatic Sprinklers for Fire-Protection Service” (11th ed. Nov. 4, 2005) (rev. Mar. 14, 2008) (UL199).

At least two fluid distribution tests were conducted. Preferably in each of the distribution tests, an average density of over 0.2 GPM/Sq. ft. and more preferably of 0.21 GPM/Sq. ft. or more. Additionally, individual pans collected at a density of over 0.15 GPM/Sq. ft. and more preferably is at least 0.17 GPM/Sq. ft. With specific reference to the center four collection pans (6, 7, 10, 11), water is preferably collected at an average density that ranges from 0.20 GPM/Sq. ft. to 0.21 GPM/Sq. ft. The preferred test sprinklers were also subjected to fire testing effectively addressing a fire of an ignited test crib centered between four test sprinklers. The fire test was performed in accordance with Section 58, “350 Pound Wood Crib Fire Test” of UL 199. Generally, water was discharged from the four test sprinklers to limit weight loss in a wood crib test fire and reduce the ceiling temperature within required test parameters: (i) weight loss no more than 20% and (ii) ceiling temperature below 530° F. By distributing fluid at a preferred density and satisfying one or more industry accepted fire test criteria, the preferred sprinkler deflector 200's and frame 100 provide for a preferred sprinkler assembly 10 for upright fire automatic sprinkler protection.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

1. A fire protection sprinkler comprising:
a body having an inlet, an outlet and an internal passageway extending between the inlet and the outlet along a longitudinal sprinkler axis; a sealing assembly disposed in the outlet to occlude the outlet of the body; two frame arms, each of the frame arms has a pedestal portion extending from the body generally parallel to the longitudinal sprinkler axis and a swept arch extending from the pedestal portion, the pedestal portion having a linear surface profile and the swept arch having curvilinear surface profile, the linear surface profile and the curvilinear surface profile defining a peripheral surface of the frame arm, an interior surface of the frame arm that confronts the longitudinal sprinkler axis and a transition surface that extends between the peripheral and interior surfaces; a boss supported via the two frame arms at a fixed location along the longitudinal sprinkler axis;
a fluid deflecting member secured to the boss and spaced from the outlet at a fixed axial distance from the outlet; and
a thermally responsive trigger disposed axially aligned along the longitudinal sprinkler axis between the sealing assembly and the fluid deflecting member,
wherein the transition surface of the frame arm includes a first lateral edge and a second lateral edge that form a trapezoidal projection with the body and the boss, the trapezoidal projection being centered along and symmetric about the longitudinal sprinkler axis.

2. The fire protection sprinkler of claim 1, wherein the linear profile of the pedestal portion comprises a generally planar area with a substantially trapezoidal perimeter defining the inner surface of the frame arm and a pair of generally symmetrical planar areas disposed about a ridge extending along the pedestal defining the peripheral surface of the frame arm, the curvilinear profile of the swept arch portion including a portion of the interior surface having a perimeter contiguous with the trapezoidal perimeter of the pedestal portion.

3. The fire protection sprinkler of claim 1, wherein the body includes two pairs of adjacent wrench flats contiguous the pedestal, and the peripheral surface of the frame arm includes a ridge.

4. The fire protection sprinkler of claim 1, wherein each of the first and second lateral edges are oblique with respect to a bisecting plane that includes the sprinkler axis.

5. The fire protection sprinkler of claim 4, wherein the first lateral edge has a first flank between the body and the boss, and the second lateral edge has a second flank between the body and the boss, the first flank being disposed in a first plane, the second flank being disposed in a second plane, the first and second planes intersecting at the longitudinal sprinkler axis.

6. The fire protection sprinkler of claim 1, wherein each frame arm is symmetrical about a bisecting plane in which lies the sprinkler axis, the transition surface of each frame arm including a pair of tapered sides disposed about the bisecting plane, the pair of tapered sides tapering toward the bisecting plane at a constant rate from the body to the boss.

7. The fire protection sprinkler of claim 1, wherein the interior surface of the frame arms in the swept arch portion is non-planar.

8. The fire protection sprinkler of claim 1, wherein the trapezoid projection defines a trapezoid perimeter having a first width proximate the sprinkler body, a second width proximate the boss and a third width proximate the junction between the pedestal portion and the swept arch portion, the nominal K factor being 8.0 such that the trapezoidal perimeter defines a first width-to-outlet diameter ratio of about 0.77:1; a second width-to-outlet diameter ratio of about 0.17:1 and a third width-to-outlet diameter ratio of about 0.4:1.

9. The fire protection sprinkler of claim 1, wherein the trapezoid projection defines a trapezoidal perimeter having a first width proximate the sprinkler body, a second width proximate the boss and a third width proximate the junction between the pedestal portion and the swept arch portion, the nominal K factor being 5.6 such that the trapezoidal perimeter defines a first width-to-outlet diameter ratio of about 0.9:1; a second width-to-outlet diameter ratio of about 0.2:1 and a third width-to-outlet diameter ratio of about 0.5:1.

10. The fire protection sprinkler of claim 1, wherein the swept arch portion defines a plurality of variable cross-sections from the pedestal portion to the boss, each cross-section defining a width and a thickness, the plurality of cross-sections defining at least three width-to-outlet diameter ratios, wherein when the nominal K factor is 8.0 such that the plurality of cross-sections defines a first width-to-outlet diameter ratio of about 0.4:1; a second width-to-outlet diameter ratio of about 0.3:1 and a third width-to-outlet diameter ratio of about 0.25:1, and the plurality of cross-sections includes six variable cross-sections, each defining a different thickness-to-outlet diameter ratio, wherein the first ratio is 0.24:1; the second ratio 0.25:1; the third ratio is 0.33:1; the fourth ratio is 0.38:1; the fifth ratio is 0.49:1 and the sixth ratio is 0.54:1; and wherein the nominal K factor is 5.6 such that the plurality of cross-sections defines a first width-to-outlet diameter ratio of about 0.5:1; a second width-to-outlet diameter ratio of about 0.4:1 and a third width-to-outlet diameter ratio of about 0.3:1 and the plurality of cross-sections includes six variable cross-sections, each defining a different thickness-to-outlet diameter ratio, wherein the first ratio is 0.29:1; the second ratio 0.3:1; the third ratio is 0.39:1; the fourth ratio is 0.46:1; the fifth ratio is 0.58:1 and the sixth ratio is 0.64:1.

11. The fire protection sprinkler of claim 1, wherein the body includes an external male thread having a first portion and a second portion different than the first portion to define a thread stop of the external thread.

12. The fire protection sprinkler of claim 11, further comprising an escutcheon assembly, the escutcheon assembly having a central opening defined by a female thread for engaging the external male thread formed along the body, the female thread is a national straight pipe thread, wherein the sprinkler body has one of: (i) a nominal K-factor of 8.0 GPM/(PSI)½ with the external male thread being ¾-14 NPT and the female thread being ¾ inch-14 NPSC; or (ii) a nominal K-factor of 5.6 GPM/(PSI)½ with the external male thread being ½-14 NPT and the female thread being ½ inch-14 NPSC.

13. The fire protection sprinkler of claim 1, wherein at least one of: (i) the fluid deflecting member is an upright deflector having an upper surface, a lower surface and periphery including a plurality of spaced apart tines about a central deflector axis with slots formed between each tine, the tines angled with respect to the lower surface to define a radius about the central deflector axis to define a deflector height at the slot formation that is greater than a deflector thickness between the upper and lower surface; and (ii) in a 16 Pan Distribution Test, the sprinkler provides for an average density of over 0.2 GPM/Sq. ft. and the central four pans in the Test collect an average density of over 0.2 GPM/Sq. ft.

14. The sprinkler of claim 13, wherein the upright deflector comprises a circular member, the deflecting member including a radius formed at the periphery about the deflector axis between the lower surface and a terminal portion of the slot formation to direct fluid downward about the sprinkler.

15. The sprinkler of claim 13, wherein each of the plurality of tines define an included angle with a line parallel to the central deflector axis that ranges from 20°-30°, the upper and lower surfaces define a thickness therebetween ranging from 0.045-0.05 inch, the lower surface and terminal end of each tine defining a first deflector height therebetween ranging from 0.1-0.2 inch, the upper surface and terminal edge of each slot formation defining a second deflector height ranging between 0.05-0.1 inch.

16. The sprinkler of claim 1, wherein the outlet is circular defining a diameter subject to a tolerance such that the any two diameters of the outlet do not vary more than 25% of the tolerance.

17.-47. (canceled)

48. A fire protection sprinkler comprising:
a body having an inlet, an outlet and an internal passageway extending between the inlet and the outlet along a longitudinal sprinkler axis, the sprinkler body having a nominal K-factor, the nominal K-factor being one of 5.6 and 8.0 GPM/(PSI)½;
a sealing assembly disposed in the outlet to occlude the outlet of the body;
two frame arms, each of the frame arms has a pedestal portion extending from the body generally parallel to the longitudinal sprinkler axis and a swept arch extending from the pedestal portion, the pedestal portion having a linear surface profile and the swept arch having curvilinear surface profile, the linear surface profile and the curvilinear surface profile defining a peripheral surface of the frame arm, an interior surface of the frame arm that confronts the longitudinal sprinkler axis and a transition surface that extends between the peripheral and interior surfaces;
a boss supported via the two frame arms at a fixed location along the longitudinal sprinkler axis;
a fluid deflecting member secured to the boss and spaced from the outlet at a fixed axial distance from the outlet; and
a thermally responsive trigger disposed axially aligned along the longitudinal sprinkler axis between the sealing assembly and the fluid deflecting member,
wherein the transition surface of the frame arm includes a first lateral edge and a second lateral edge that form a trapezoidal projection with the body and the boss, the trapezoidal projection being centered along and symmetric about the longitudinal sprinkler axis.

49. The fire protection sprinkler of claim 48, wherein the linear profile of the pedestal portion comprises a generally planar area with a substantially trapezoidal perimeter defining the inner surface of the frame arm and a pair of generally symmetrical planar areas disposed about a ridge extending along the pedestal defining the peripheral surface of the frame arm, the curvilinear profile of the swept arch portion including a portion of the interior surface having a perimeter contiguous with the trapezoidal perimeter of the pedestal portion.

50. The fire protection sprinkler of claim 48, wherein the body includes two pairs of adjacent wrench flats contiguous the pedestal, and the peripheral surface of the frame arm includes a ridge.

51. The fire protection sprinkler of claim 48, wherein each of the first and second lateral edges are oblique with respect to a bisecting plane that includes the sprinkler axis.

52. A fire protection sprinkler, comprising:
a body having an inlet, an outlet and an internal passageway extending between the inlet and the outlet along a longitudinal sprinkler axis, the body having a nominal K-factor being one of 5.6 and 8.0 GPM/(PSI)½;
a sealing assembly disposed in the outlet to occlude the outlet of the body;
two frame arms each having a pedestal portion extending from the body generally parallel to the longitudinal sprinkler axis and a swept arch portion, the pedestal portion having a linear profile and the swept arch having a curvilinear profile, the linear profile and the curvilinear profile defining a transition surface between a peripheral surface of the frame arm and an interior surface of the frame arm that confronts the longitudinal sprinkler axis;
a boss supported via the two frame arms at a fixed location along the longitudinal sprinkler axis with the swept arch portion of each frame arm being between the boss the two pedestal portions;
a fluid deflecting member secured to the boss and spaced from the outlet at a fixed axial distance from the outlet; and
a thermally responsive trigger disposed axially aligned along the longitudinal sprinkler axis between the sealing assembly and the fluid deflecting member,
wherein the transition surface of the frame arms includes a first lateral edge and second lateral edge, the first lateral edge having a first flank between the body and the boss, and the second lateral edge having a second flank between the body and the boss, the first flank being disposed in a first plane, the second flank being disposed in a second plane, the first and second planes intersecting at the longitudinal sprinkler axis.

53.-65. (canceled)
